(19) United States
(12) Patent Application Publication
(10) Pub. No.: US 2019/0232809 A1
(43) Pub. Date: Aug. 1, 2019

(54) SAFETY SYSTEM FOR AN ELECTROMECHANICAL COUPLING ASSEMBLY, CHARGING STATION FOR AN ELECTRIC VEHICLE PROVIDED WITH SUCH A SYSTEM AND ASSOCIATED COUPLING METHOD

(71) Applicant: BLUETRAM, Puteaux Cedex (FR)

(72) Inventors: Eric BAYLARD, Le Relecq Kerhuon (FR); Marc DERRIEN, Concarneau (FR)

(21) Appl. No.: 16/063,973

(22) PCT Filed: Dec. 15, 2016
(86) PCT No.: PCT/EP2016/081262

§ 371 Date: Jun. 19, 2018

(30) Foreign Application Priority Data
Jan. 6, 2016 (FR) 1650071

(51) Int. Cl. B60L 53/16; B60L 53/60; B60L 53/35; H01R 13/631; H01R 13/66

(52) U.S. Cl. CPC B60L 53/16; B60L 53/60; B60L 53/35; H01R 13/631; B60Y 2200/143; B60L 2200/18; B60Y 2200/91; B60Y 2300/91; H01R 13/6683

(57) ABSTRACT

A safety system for an electromechanical coupling assembly for being fitted to a charging station and an electric vehicle, a corresponding electromechanical coupling assembly and charging station, as well as a method for electromechanically coupling an electric vehicle to a charging station. The present safety system includes: a detectable element secured to a first connecting part of the coupling assembly; a sensor secured to a second connecting part, the sensor being configured to detect whether the detectable element is located in proximity; and a control unit driving a movement of the first connecting part from a folded position to a proximate position with a force, the amplitude of which is lower than a maximum amplitude F1 max, and controlling a movement of the first connecting part from the proximate position to a connecting position with a force, the amplitude of which is higher than the maximum amplitude F1 max.

### TECHNICAL FIELD

The invention relates to the field of charging of electric vehicles. More specifically, it relates to the field of automatic devices for electromechanical coupling allowing charging of electric vehicles from a charging station. The invention applies in particular to automatic devices allowing charging of electric vehicles, more particularly public transport vehicles, such as buses and tramcars. More specifically, the invention relates to a safety system for an electromechanical coupling assembly, capable of equipping a charging station and an electric vehicle. The invention also relates to the corresponding electromechanical coupling assembly and charging station, as well as a coupling (or approach) method for an electric vehicle vis-à-vis a charging station.

### PRIOR ART

Electric vehicles comprising an electric drive train traditionally carry on board at least one energy storage device, for example in electrochemical form or capacitive form. Charging the energy storage device with energy can be carried out via an energy converter carried on board the vehicle. This energy converter can in particular be arranged in order to recover the kinetic energy of the vehicle during braking phases. Charging the storage device with energy can also be carried out from a charging station, for example placed at a stopping station provided for the boarding and alighting of passengers. Most of the time, the transfer of electrical energy between the charging station and the electric vehicle is carried out by an electromechanical coupling assembly divided between the charging station and the electric vehicle. The electromechanical coupling assembly comprises a first connection part, electrically connected to an electrical supply source of the charging station, and a second electrical connection part, electrically connected to the energy storage device of the vehicle. These connection parts are capable of mechanical coupling so as to make an electrical contact between the charging station and the energy storage device, allowing an electric charging current to flow.

In order to facilitate charging and in particular to avoid all human intervention, it is possible to automate the electromechanical coupling operation and, more generally, all of the operations necessary for charging the electric vehicle. The electromechanical coupling assembly thus generally comprises an actuator, arranged in order to move one of the connection parts relative to the other connection part, and a control unit, arranged in order to drive the actuator in an automated manner, for example following a charging instruction. By way of example, EP 1 938 438 describes an electromechanical coupling assembly comprising an extensible arm arranged on the roof of a vehicle and intended to connect in a socket with which the charging station is equipped.

A drawback of the electromechanical coupling assemblies of the state of the art is that, during an approach phase of the mobile element (male or female) towards the fixed element (male or female, respectively) in order to establish the coupling thereof, there is a risk that a foreign body may be introduced between the male element and the female element. The foreign body can in particular prevent the coupling between the male and female elements, or the connection between these elements. The foreign body can also be a limb or a part of a limb of a human being or an animal. In addition to the risk of incorrect coupling is thus added a risk of injury. In order to limit these risks, the coupling of the male part and the female part must be carried out with particular constraints, regulated by standards in certain countries.

In the context of the charging of an electric vehicle, the risks of injury and of damage can be limited by providing for an installation of the electromechanical coupling assembly at a height greater than a threshold height. For a public transport vehicle of the bus or tram type, this threshold height is for example set at 2.70 m, so as to prevent the introduction of a user's hand into the female element. However, such an installation at height requires a minimum height for the vehicle, which can be incompatible with certain routes that the vehicle must travel, for example, routes comprising height-limited access (tunnels, bridges). When the electromechanical coupling assembly cannot be installed above a threshold height, it is possible to limit the risk of injury by setting a maximum strength for the force applied during the movement of the mobile element towards the fixed element. This maximum strength is for example equal to 70 N, in order to prevent any injury to a user, even in the event of pinching. However, a correct coupling of the male element with the female element generally requires a relatively significant force, called insertion force, the strength of this force being capable for example of exceeding 800 N. In particular, such a force is recommended due to imperfect alignment of the male element with the female element, as the electric vehicle is only able to position itself approximately with respect to the charging station. Furthermore, the need to carry out effective coupling of the coupling unit is underlined by the fact that an electric current of a relatively significant amperage flows through it in order to charge the electric vehicle.

A solution for positioning the coupling assembly at a relatively low height, while allowing a strong insertion force would be to determine the position of the mobile element relative to the support thereof, for example the charging station, and to deduce therefrom the position thereof with respect to the vehicle. In particular, in the case where the mobile element is moved along an axis perpendicular to a longitudinal axis of the road; the position thereof relative to the fixed element can be determined from the distance of displacement thereof along this axis. The mobile element can then be moved firstly with a relatively limited force, and secondly with a greater force, in order to ensure correct coupling. A risk exists, however, from the fact that the positioning of the electric vehicle risks varying between different successive chargings. Thus, if the vehicle is too close to the charging station, the position from which the force is increased risks not being reached. Conversely, if the vehicle is positioned too far from the charging station, the position from which the force is increased is reached while the space between the male element and the female element is sufficient for a foreign body to be inserted therein.

US 2009/079388 describes a connection device comprising means for detecting the position of the female element and adjusting the movement of the male element so that it couples accurately with the female element. The connection device can be arranged in order to detect the presence of an obstacle and react either by retracting the male element or by avoiding the obstacle. This solution involves the use of an actuator and relatively complex detection means. In particular, the detection means must be able to distinguish the female element from an obstacle. When it is sought to avoid the obstacle, the actuator must then be able to carry out a complex movement, composed of several translational and/or rotational movements. The coupling assembly is thus relatively complex and costly to make.

### SUMMARY OF THE INVENTION

A purpose of the invention is in particular to overcome the above-mentioned drawbacks entirely or in part by proposing a safety system for an electromechanical coupling assembly which makes it possible to correctly couple two complementary connection elements, i.e. applying a sufficient insertion force, while guaranteeing the safety of property and people during coupling. For this purpose, the invention proposes to equip one of the connection parts of the electromechanical coupling assembly with a detectable element and to equip the other connection part with a sensor configured in order to determine if the detectable element is situated or not situated in proximity. The detectable element and the sensor are arranged on the connection parts so that the detection only operates when the connection parts are sufficiently close to one another to prevent the insertion of a foreign body between these parts. The mobile connection part can then be moved with a relatively low-strength force in a first phase and with greater force in a second phase, in which the risk of introduction of a foreign body is limited or nonexistent.

More specifically, a subject of the invention is a safety system for an electromechanical coupling assembly capable of equipping a charging station and an electric vehicle. The electromechanical coupling assembly intended to be equipped with the safety system can comprise:
a first connection part,
a second connection part, the first and second connection parts being arranged in order to be able to couple together electrically and mechanically, and
an actuator arranged in order to be able to move the first connection part relative to the second connection part between a connection position, in which the connection parts are coupled to each other, and a retracted position, in which the connection parts are not coupled to each other.
   The safety system comprises:
a detectable element, firmly fixed to one of the connection parts,
a sensor, firmly fixed to the other connection part, the sensor being configured in order to provide a detection signal having a value called detection value, when the detectable element is situated within a predetermined proximity to the sensor, and a value called non-detection value, when the detectable element is situated outside the predetermined proximity to the sensor, the detectable element and the sensor being arranged so that when the first connection part is situated in a position called proximity position, intermediate between the retracted position and the connection position, the sensor provides a detection signal having said detection value, and
a control unit, arranged in order to drive the actuator as a function of said detection signal, the control unit controlling a movement of the first connection part from the retracted position to the proximity position, with a force the amplitude of which is less than or equal to a maximum amplitude F₁ₘₐₓ, and controlling a movement of the first connection part from the proximity position to the connection position, with a force the amplitude of which is greater than said maximum amplitude F₁ₘₐₓ.

The predetermined proximity to the sensor is for example delimited by a sphere centred on the sensor and having a predetermined radius. The radius is for example equal to 50 mm. In practice, the surroundings of the sensor and the detection technology used generally define a more complex outline for this predetermined proximity.

In the retracted position, the sensor is sufficiently distant from the detectable element so as not to be detected. It then provides a signal having the non-detection value.

The proximity position corresponds to an intermediate position between the retracted position and the connection position. It is determined by the detection of the detectable element by the sensor. Thus, it always corresponds to one and the same relative position between the two connection parts, or optionally to one and the same set of relative positions between the connection parts. In the case where the coupling of the connection parts is carried out by a translational movement of one of the connection parts, the intermediate position is defined by a certain travel of the connection part. This travel is not defined in a fixed manner but depends on the relative position of the electric vehicle and the charging station.

Advantageously, the sensor and the detectable element are positioned on the connection parts so that, in the intermediate position, i.e. the position in which the sensor detects (or begins to detect) the detectable element, the connection parts are sufficiently close to each other to prevent the insertion of a foreign body between them.

Between the proximity position and the connection position, the movement of the first connection part can be carried out with a force the amplitude of which is greater than that of the force leading to the movement of this first connection part between the retracted position and the proximity position. In particular, the control unit can be arranged in order to control a movement of the first connection part from the proximity position to the connection position with a force the amplitude of which is greater than a minimum amplitude F₂ₘᵢₙ. This minimum amplitude F₂ₘᵢₙ is typically greater than the maximum amplitude F₁ₘₐₓ.

The minimum amplitude F₂ₘᵢₙ is preferably determined so as to allow correct coupling of the connection parts. It can in particular depend on the intrinsic mechanical constraints of the connection elements, and manufacturing tolerances of these elements. It is for example greater than or equal to 350 N, for example of the order of 450 N.

According to a particular embodiment, the sensor is firmly fixed to the first connection part and the detectable element is firmly fixed to the second connection part. This embodiment is of particular benefit when the coupling of the connection parts is carried out by a movement of the first connection part. The sensor can then provide detection information to the actuator without any data link (wired or wireless) between the electric vehicle and the charging station.

The first connection part comprises for example a male element and the second connection part a female element. The female element is then arranged in order to be able to receive the male element during a coupling. Preferably, the detectable element and the sensor are arranged so that, in the proximity position, the male element is partially inserted into the female element. The concept of proximity between the connection parts then corresponds to a partial insertion of the male element into the female element.

According to a particular embodiment, the male element comprises a first tube and a second tube arranged end to end, optionally in a concentric manner, the first tube having a first diameter and the second tube having a second diameter, strictly less than the first diameter. The female element comprises a first bore and a second bore arranged end to end, optionally in a concentric manner, the first bore having a third diameter and the second bore having a fourth diameter, strictly less that the third diameter and the first diameter, the male element and the female element being arranged so that, in the connection position, the first tube is inserted into the first bore and the second tube is inserted into the second bore. The first and third diameters can be equal, give or take a small working clearance. Similarly, the second and fourth diameters can be equal, give or take a small working clearance. The detectable element and the sensor can then be arranged so that, in the proximity position, the second tube is inserted at least partially into the first bore.

Advantageously, the detectable element and the sensor are arranged so that, in the proximity position, the second tube is also inserted partially into the second bore. In other words, the second tube is inserted into the first bore and partially into the second bore.

In the context of the present invention, a partial insertion of a male element into a female element means that the male element has entered the female element without having reached a final position of travel, corresponding to the connection position.

The first and the second tube can have a globally cylindrical shape, for example with a circular cross-section. The tubes can also have other shapes. In this case, the diameters in question are the diameters of circles circumscribed to the cross-section of the tubes.

According to the latter particular embodiment, the sensor can be situated at a free end of the second tube and the detectable element situated at a junction between the first bore and the second bore.

According to another particular embodiment, the male element comprises a single tube having a first diameter and the female element comprises a single bore having a second diameter. The male element and the female element can then be arranged so that, in the proximity position, the tube is partially inserted into the bore. The first and second diameters can be equal, give or take a small working clearance.

According to a first variant embodiment, the operation of the sensor is based on purely magnetic properties. The detectable element comprises for example a magnet and the sensor a magnetic sensor. This variant embodiment has the advantage of not introducing an electromagnetic field capable of disturbing the electrical signals passing through the electric conductors situated in proximity to the safety system. In this case, the electromechanical coupling assembly can comprise an end-of-travel sensor operating by electrical contact, as shown below. The operation of this end-of-travel sensor is not influenced by the presence of the magnet.

According to a second variant embodiment, the operation of the sensor is based on radio-frequency identification technology, better known by the acronym “RFID”. The detectable element comprises for example a radio-frequency identification tag and the sensor a radio-frequency identification reader. The use of RFID technology makes it possible for the sensor to identify the connection part bearing the RFID tag. It can in particular be used in order to verify the matching ability of the connection parts or in order to change the charging of the electric vehicle, for example the voltage applied for the charging.

The detectable element is for example mounted in the electric vehicle and arranged in order to transmit a piece of identification information of the electric vehicle to the sensor when the detectable element is situated within the predetermined proximity to the sensor. This identification information can in particular be used in order to verify that the electric vehicle is adapted to a charging at the charging station or that it is authorized to charge at this charging station.

The maximum amplitude F₁ₘₐₓ is preferably determined so as to limit or even prevent any risk of injury to a person. It is more particularly less than or equal to 100 N, for example of the order of 70 N.

A subject of the invention is also an electromechanical coupling assembly capable of equipping a charging station and an electric vehicle. The electromechanical coupling assembly comprises:
a first connection part,
a second connection part, the first and second connection parts being arranged in order to be able to couple electrically and mechanically,
an actuator arranged in order to be able to move the first connection part relative to the second connection part between a connection position, in which the connection parts are coupled to each other, and a retracted position, in which the connection parts are not coupled to each other, and
a safety system as described above.

According to a particular embodiment, the actuator is arranged in order to be able to move the first connection part relative to the second connection part by a translational movement, the male element and the female element being capable of coupling by means of this translational movement. The actuator comprises for example a hydraulic cylinder or a mechanism of the endless screw type.

The electromechanical coupling assembly can also comprise an end-of-travel sensor, arranged in order to detect a positioning of the first connection part in the connection position. In other words, the end-of-travel sensor can be arranged in order to detect the end of the coupling phase of the connection parts. This positioning information can in particular be used in order to initiate a transfer of electrical energy from the charging station to the electric vehicle.

A subject of the invention is also a charging station for charging an electric vehicle with electrical energy. The charging station comprises:
an electrical supply source,
a first connection part, electrically connected to the electrical supply source and capable of coupling electrically and mechanically with a second connection part of the electric vehicle,
an actuator arranged in order to be able to move the first connection part relative to the second connection part between a connection position, in which the connection parts are coupled to each other, and a retracted position, in which the connection parts are not coupled to each other,
a sensor, firmly fixed to the first connection part and configured in order to provide a detection signal having a value called detection value, when a detectable element that is firmly fixed to the second connection part is situated within a predetermined proximity to the sensor, and a value called non-detection value, when the detectable element is situated outside the predetermined proximity to the sensor, said sensor being arranged relative to the detectable element so that, when the first connection part is situated in a position called proximity position intermediate between the retracted position and the connection position, the sensor provides a detection signal having the detection value, and
a control unit, arranged in order to drive the actuator as a function of said detection signal, the control unit controlling a movement of the first connection part from the retracted position to the proximity position, with a force the amplitude of which is less than or equal to a maximum amplitude F₁ₘₐₓ, and controlling a movement of the first connection part from the proximity position to the connection position, with a force the amplitude of which is greater than said maximum amplitude F₁ₘₐₓ.

The different features described with reference to the safety system and the electromechanical coupling assembly apply to the charging station.

Finally, a subject of the invention is a method for electromechanical coupling of an electric vehicle with a charging station, the charging station comprising:
an electrical supply source, and
a first connection part, electrically connected to the electrical supply source and capable of having a connection position, in which it is electrically and mechanically coupled to a second connection part of the electric vehicle, a retracted position, in which it is not coupled to the second connection part, and a position called proximity position, in which it is situated in an intermediate position between the retracted position and the connection position.
   The coupling method comprises a step of moving the first connection part relative to the second connection part, with a force the amplitude of which is less than or equal to a maximum amplitude F₁ₘₐₓ, between the retracted position and the proximity position, and with a force the amplitude of which is greater than said maximum amplitude F₁ₘₐₓ between the proximity position and the connection position.

According to a particular embodiment, the coupling method comprises, during the step of moving the first connection part relative to the second connection part, a monitoring step, in which it is ascertained whether the first connection part is positioned or not positioned in the intermediate position using a sensor firmly fixed to one of the connection parts and a detectable element connected the other connection part, the detectable element capable of being detected by the sensor.

### DESCRIPTION OF THE FIGURES

Other advantages and features of the invention will become apparent on reading the detailed description of implementations and embodiments which are in no way limitative, with respect to the attached drawings, in which:

FIG. 1 is a diagrammatic representation of an example of an electric vehicle and its charging station equipped with a safety system according to the invention;

FIG. 2 shows a first example of the electromechanical coupling assembly equipped with the safety system according to the invention, in a position called retracted position;

FIG. 3 shows the coupling assembly of FIG. 2, in a position called proximity position;

FIG. 4 shows the coupling assembly of FIGS. 2 and 3, in a position called connection position; and

FIG. 5 shows a second example of the electromechanical coupling assembly equipped with the safety system according to the invention, in the retracted position.

### DESCRIPTION OF THE EMBODIMENTS

The embodiments described below are in no way limitative; it is possible in particular to consider variants of the invention comprising only a selection of characteristics described, in isolation from the other characteristics described, if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

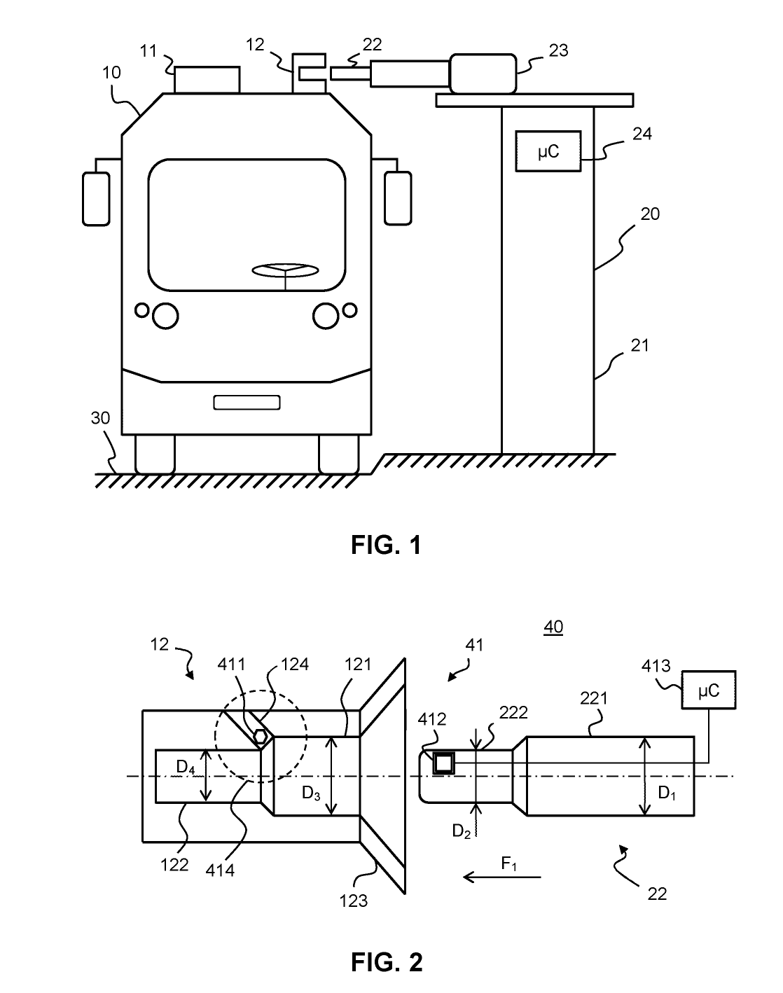

FIG. 1 shows diagrammatically, in a front view, an electric vehicle, for example of the bus or tyred tram type, positioned in proximity to a charging station so as to allow the charging thereof with electrical energy. The expression “tyred tram” denotes an electric public transport land vehicle mounted on wheels and which is charged at stations, so that it has no need for heavy infrastructures of the rails or catenaries type on the road system. Such an electric vehicle is charged at each station by means of charging elements of the station and a connector connecting said vehicle to said station. The electric vehicle 10 comprises an electrical energy storage device 11, for example of the battery or supercapacitor type, and a connection part 12 comprising a female element. The storage device 11 is electrically connected to a drive train of the electric vehicle 10 (not shown), so as to provide the electrical energy necessary for the movement thereof. It is also electrically connected to the connection part 12 so as to be able to receive the electrical energy originating from the charging station 20.

The charging station 20 is for example placed near to a traffic lane 30, for example at a stopping point, or station, provided for the boarding and alighting of passengers. The charging station 20 comprises a body structure 21, a connection part 22, an actuator 23 and a control unit 24. It also comprises an electrical supply source (not shown). The supply source can comprise a pair of electrical terminals capable of being electrically connected to the connection part 22. It can also comprise a controlled switch and/or an energy converter such as a rectifier and, more generally, any electrotechnical system allowing the operation of charging and discharging an electrical energy storage device from a supply source. The actuator 23 is mounted on an upper end of the body structure 21, so as to limit access thereto by users of the electric vehicle. The connection part 22 comprises a male element intended to couple with the female element of the connection part 12. It is mounted on a mobile part of the actuator 23, so as to be able to adopt a position called retracted position, in which is it not coupled to the connection part 12, and a connection position, in which it is coupled to the connection part 12. In the retracted position, the connection part 22 must be sufficiently distant from the traffic lane 30 so as to not constitute a possible obstacle for the electric vehicle 10, when it travels on the traffic lane 30, and in particular when it is positioned in proximity to the charging station 20 in order to be charged. In FIG. 1, the connection part 22 is situated in an intermediate position between the retracted position and the connection position. The actuator 23 comprises for example a hydraulic cylinder, arranged in order to move the connection part 22 along an axis of translation perpendicular to the longitudinal axis of the traffic lane 30. The control unit 24 is arranged in order to drive the actuator 23 and the supply source. In particular, it can control the actuator 23 so as to position the connection part 22 in the retracted position or in the connection position. The control unit 24 can also control the transfer of electrical energy between the supply source and the storage device 11, for example by driving the opening of a controlled switch situated between the supply source and the connection part 22.

FIGS. 2, 3 and 4 show in more detail, in a longitudinal cross-section view, a first embodiment example of an electromechanical coupling assembly according to the invention. They show this coupling assembly in a position called retracted position, in a position called proximity position and in a position called connection position, respectively. By way of illustration, the electromechanical coupling assembly is described as corresponding to that in FIG. 1. This electromechanical coupling assembly 40 comprises the connection part 12 mounted on the electric vehicle 10, the connection part 22 mounted on the charging station 20 and the actuator 23 (not shown in these figures). The connection part 22 comprises a first cylindrical tube 221 and a second cylindrical tube 222 arranged end to end in a concentric manner. The cylindrical tube 222 is situated at the free end of the connection part 22. The cylindrical tube 221 has a diameter D₁, for example equal to 50 mm, and the cylindrical tube 222 has a diameter D₂, for example equal to 40 mm. The diameter D₂ must be strictly less than the diameter D₁. They cylindrical tubes 221 and 222 have for example a circular cross-section. They form a male element of the connection part 22. In a complementary manner, the connection part 12 comprises a first bore 121 of diameter D₃ and a second bore 122 of diameter D₄. The diameters D₁ and D₃ can be substantially equal, the diameter D₁ being preferentially less than the diameter D₃ in order to permit a working clearance. Similarly, the diameters D₂ and D₄ can be substantially equal, the diameter D₂ being preferentially less than the diameter D₄ in order to allow a working clearance. The connection part 12 also comprises a receiving cone 123, arranged in order to mechanically guide the connection part 22 during coupling thereof with the connection part 12. Through a first end, the bore 121 opens onto the bore 122 and through a second end, onto the receiving cone 123. The bores 121 and 122 have a shape that is complementary to the cylindrical tubes 221 and 222, respectively, in order to allow an insertion of the cylindrical tube 221 into the bore 121 and a simultaneous insertion of the cylindrical tube 222 into the bore 122. In this configuration, the position of connection between the connection parts 12 and 22 is defined by the position in which the cylindrical tube 221 abuts against the bore 122, as shown in FIG. 4.

The electromechanical coupling assembly 40 also comprises a safety system 41 arranged in order to couple the connection parts 12 and 22 with a variable strength of force as a function of the relative proximity of these connection parts. The safety system 41 comprises a detectable element 411, a sensor 412 and a control unit 413. The sensor 412 is firmly fixed to the connection part 22. It is mounted at an end of the cylindrical tube 222, for example in a housing made in the cylindrical tube 222. The detectable element 411 is placed, for example, in an orifice 124 of the connection part 12, opening one the one hand onto an outer surface of the connection part 12 and on the other hand onto the junction of the bores 121 and 122. The detectable element 411 is firmly fixed to the connection part 12. It is for example inserted into the connection part 12 by placing it on the end of a screw capable of being screwed into the bore 124. The detectable element 411 and the sensor 412 are arranged with respect to each other so that the sensor 412 can detect the detectable element 411 when it reaches proximity to the junction between the bores 121 and 122. The area, called detection area, in which the detectable element 411 is capable of being detected by the sensor 412 is shown by a circle 414. This circle shows diagrammatically a spherical shape the centre of which is situated at the detectable element 411. The radius of the circle 414 is for example equal to 50 mm. Of course, the detection area is diagrammatic, the outline thereof in particular able to be influenced by the geometry and the material of the connection part 12, as well as by the detection technology used by the sensor 412. Moreover, the sensor 412 and the detectable element 411 must be arranged so that the detection area has a shape adapted to the dimensions of the connection parts 12 and 22.

The sensor 412 is fixed to the connection part 22 and, more particularly, at the free end of the cylindrical tube 222. It is for example inserted into a housing made in the cylindrical tubes 221 and 222. This housing (not shown) opens for example onto the end of the cylindrical tube 221 opposite the junction with the cylindrical tube 222. The sensor 412 is arranged in order to provide a detection signal to the control unit 413 as a function of the detection of the detectable element 411. The detection signal has a value called detection value, when the sensor 412 detects the detectable element 411, and a value called non-detection value otherwise. The detection signal can be transmitted by wired transmission means or wireless transmission means. The sensor 412 comprises for example a magnetic sensor. The detectable element 411 can then be a simple magnet. The sensor 412 can alternatively comprise a radio-frequency identification (RFID) reader. The detectable element 411 is then an RFID tag, arranged in order to exchange identification data. The RFID tag can in particular store and communicate data relative to the electric vehicle equipped therewith. These data are not necessarily processed for their content but may be used only to indicate the proximity of the RFID tag to the RFID reader.

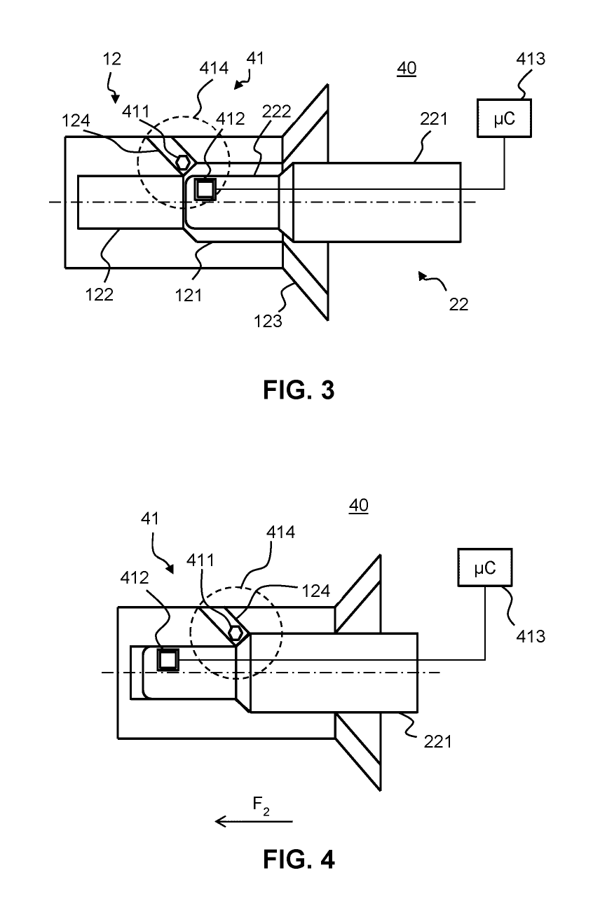

The positioning of the detectable element 411 on the connection part 12 and of the sensor 412 on the connection part 22 makes it possible to identify a position called proximity position of the connection part 22 with respect to the connection part 12, as shown in FIG. 3. In this position, the cylindrical tube 222 is inserted into the bore 121 but is not inserted into the bore 122. In this position, coupling between the connection parts 12 and 22 is thus only partial. This partial coupling generally no longer allows the introduction of a foreign body between the connection parts 12 and 22. It should be noted that, depending on the respective positions of the detectable element 411 and of the sensor 412, the detection can be effective for several relative positions of the connection parts 12 and 22. In this case, several proximity positions are defined. However, the proximity position of most benefit is the first observed during a coupling.

FIG. 4 shows the electromechanical coupling assembly 40 in the connection position. In this position, the connection parts 12 and 22 are coupled and allow a transfer of electric current from the charging station 20 to the electric vehicle 10. The cylindrical tube 221 is inserted into the bore 121 and abuts against the bore 122. The cylindrical tube 222 is inserted into the bore 122 without abutting against the bottom of this bore 122.

The control unit 413 is arranged in order to influence the behaviour of the actuator 23 as a function of the detection signal. It is thus connected to the control unit 24 driving the actuator 23. In a particular embodiment, the control unit 413 is integrated into a control unit 24. More precisely, the control unit 413 is arranged in order to control a movement of the connection part 22 from the retracted position to the proximity position, with a force the amplitude F₁ of which is less than or equal to a maximum amplitude F₁ₘₐₓ and controlling a movement of the connection part 22 from the proximity position to the connection position, with a force the amplitude F₂ of which is greater than or equal to the maximum amplitude F₁ₘₐₓ. More particularly, the amplitude F₂ can be greater than a minimum amplitude F₂ₘᵢₙ. The minimum amplitude F₂ₘᵢₙ is greater than the maximum amplitude F₁ₘₐₓ. The minimum amplitude F₂ₘᵢₙ is for example equal to 450 N and the maximum amplitude F₁ₘₐₓ is equal to 70 N. Thus, before any detection, i.e. between the retracted position and the proximity position, the maximum effort involved for the movement of the connection part 22 is relatively limited, thus preventing injuries or damage being caused in the case of insertion of a foreign body. However, after a first detection, i.e. between the proximity position and the connection position, the connection part 22 is moved with a greater force, allowing a correct coupling with the connection part 12.

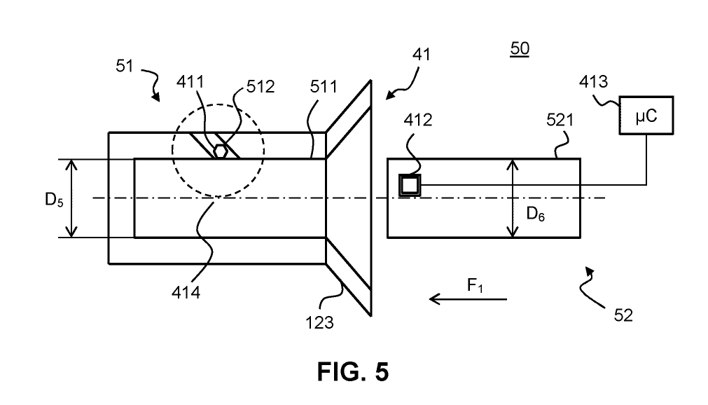

FIG. 5 shows, in a longitudinal cross section view similar to FIGS. 2 to 4, a second embodiment example of an electromechanical coupling assembly 50 according to the invention. In this embodiment example, the connection part 51 of the electric vehicle 10 comprises a female element formed by a single bore 511 and the connection part 52 of the charging station 20 comprises a male element formed by a single cylindrical tube 521. The bore 511 has a diameter D₅ and the cylindrical tube 521 has a diameter D₆. These diameters D₅ and D₆ are for example equal to 50 mm. The diameters can differ in order to introduce a working clearance and facilitate coupling of the connection parts 51 and 52. The connection part 51 also comprises a receiving cone 123 in which the bore 511 ends. The receiving cone 123 is arranged in order to guide the connection part 52 during coupling thereof. The electromechanical coupling assembly 50 is also equipped with the safety system 41 described with reference to FIGS. 2 to 4. The detectable element 411 is firmly fixed to the connection part 51. It is for example inserted into an orifice 512 of the connection part 51, opening on the one hand onto an outer surface of the connection part 51 and on the other hand into the bore 511. The sensor 412 is firmly fixed to the connection part 52. It is for example inserted into a housing formed at a free end of the cylindrical tube 521.

In FIG. 5, the electromechanical coupling assembly 50 is shown in the retracted position, the cylindrical tube 521 not being inserted (even partially) into the bore 511 and the sensor 412 not detecting the detectable element 411. In the proximity position (not shown), the cylindrical tube 521 is partially inserted into the bore 511, the sensor 412 detecting the detectable element 411. The coupling of the connection parts 51 and 52 is then completed with a force of greater amplitude. In the connection position, the cylindrical tube 521 abuts for example against the bottom of the bore 511.

Of course, the invention is not limited to the examples which have just been described and numerous adjustments can be made to these examples without exceeding the scope of the invention. In particular, the connection part 12 is shown in FIG. 1 as being installed on a roof of the electric vehicle 10. However, the connection part 12 can be situated on another part, in particular at the junction between the roof and a side of the electric vehicle 10 or at the frame of the electric vehicle 10, the connection part 22 coupling with the connection part 12 by movement along a vertical axis. In addition, the different characteristics, forms, variants and embodiments of the invention can be combined together in various combinations to the extent that they are not incompatible or mutually exclusive.

1. A safety system for an electromechanical coupling assembly capable of equipping a charging station and an electric vehicle, the electromechanical coupling assembly comprising:
a first connection part;
a second connection part, the first and second connection parts being arranged in order to be able to couple together electrically and mechanically; and
an actuator arranged in order to be able to move the first connection part relative to the second connection part between a connection position, in which the connection parts are coupled to each other, and a retracted position, in which the connection parts are not coupled to each other,
the safety system comprising:
a detectable element, firmly fixed to one of the connection parts;
a sensor, firmly fixed to the other connection part, the sensor being configured in order to provide a detection signal having a value called detection value, when the detectable element is situated within a predetermined proximity to the sensor, and a value called non-detection value, when the detectable element is situated outside the predetermined proximity to the sensor, the detectable element and the sensor being arranged so that, when the first connection part is situated in a position called proximity position, intermediate between the retracted position and the connection position, the sensor provides a detection signal having said detection value; and
a control unit, arranged in order to drive the actuator as a function of said detection signal, the control unit controlling a movement of the first connection part from the retracted position to the proximity position, with a force the amplitude of which is less than or equal to a maximum amplitude F₁ₘₐₓ, and controlling a movement of the first connection part from the proximity position to the connection position, with a force the amplitude of which is greater than said maximum amplitude F₁ₘₐₓ.

2. The safety system according to claim 1, in which the control unit is arranged in order to control a movement of the first connection part from the proximity position to the connection position with a force the amplitude of which is greater than a minimum amplitude F₂ₘᵢₙ, said minimum amplitude F₂ₘᵢₙ being greater than said maximum amplitude F₁ₘₐₓ.

3. The safety system according to claim 2, in which said minimum amplitude F₂ₘᵢₙ is greater than or equal to 350 N, for example of the order of 450 N.

4. The safety system according to claim 1, in which the sensor is firmly fixed to the first connection part, the detectable element being firmly fixed to the second connection part.

5. The safety system according to claim 1, in which the first connection part comprises a male element and the second connection part comprises a female element, the female element being arranged in order to be able to receive the male element during a coupling, the detectable element and the sensor being arranged so that, in the proximity position, the male element is partially coupled to the female element.

6. The safety system according to claim 5, in which the male element comprises a first tube and a second tube arranged end to end, the first tube having a first diameter (D₁) and the second tube having a second diameter (D₂), strictly less than the first diameter (D₁), the female element comprising a first bore and a second bore arranged end to end, the first bore having a third diameter (D₃) and the second bore having a fourth diameter (D₄), strictly less than the third diameter (D₃) and the first diameter (D₁), the male element and the female element being arranged so that, in the connection position, the first tube is inserted into the first bore and the second tube is inserted into the second bore, the detectable element and the sensor being arranged so that, in the proximity position, the second tube is inserted at least partially into the first bore.

7. The safety system according to claim 6, in which the detectable element and the sensor are arranged so that, in the proximity position, the second tube is partially inserted into the second bore.

8. The safety system according to claim 6, in which the sensor is situated at a free end of the second tube, the detectable element being situated at a junction between the first bore and the second bore.

9. The safety system according to claim 5, in which the male element comprises a single tube and the female element comprises a single bore, the male element and the female element being arranged so that, in the proximity position, the tube is partially inserted into the bore.

10. The safety system according to claim 1, in which the detectable element comprises a magnet and the sensor comprises a magnetic sensor.

11. The safety system according to claim 1, in which the detectable element comprises a radio-frequency identification tag and the sensor comprises a radio-frequency identification reader.

12. The safety system according to claim 1, in which the detectable element is mounted in the electric vehicle and is arranged in order to transmit a piece of identification information of the electric vehicle to the sensor when the detectable element is situated within the predetermined proximity to the sensor.

13. The safety system according to claim 1, in which said maximum amplitude F₁ₘₐₓ is less than or equal to 100 N, for example of the order of 70 N.

14. An electromechanical coupling assembly capable of equipping a charging station and an electric vehicle, the electromechanical coupling assembly comprising:
a first connection part;
a second connection part, the first and second connection parts being arranged in order to be able to couple electrically and mechanically;
an actuator arranged in order to be able to move the first connection part relative to the second connection part between a connection position, in which the connection parts are coupled to each other, and a retracted position, in which the connection parts are not coupled to each other; and
a safety system according to claim 1.

15. The electromechanical coupling assembly according to claim 14, comprising a safety system in which the first connection part comprises a male element and the second connection part comprises a female element, the female element being arranged in order to be able to receive the male element during a coupling, the detectable element and the sensor being arranged so that, in the proximity position, the male element is partially coupled to the female element, the actuator being arranged in order to be able to move the first connection part relative to the second connection part by a translational movement, the male element and the female element being capable of coupling by means of this translational movement.

16. The electromechanical coupling assembly according to claim 14, also comprising an end-of-travel sensor, arranged in order to detect a positioning of the first connection part in the connection position.

17. A charging station for charging an electric vehicle with electrical energy, the charging station comprising:
an electrical supply source;
a first connection part, electrically connected to the electrical supply source and capable of coupling electrically and mechanically with a second connection part of the electric vehicle;
an actuator arranged in order to be able to move the first connection part relative to the second connection part between a connection position, in which the connection parts are coupled to each other, and a retracted position, in which the connection parts are not coupled to each other;
a sensor firmly fixed to the first connection part and configured in order to provide a detection signal having a value called detection value, when a detectable element firmly fixed to the second connection part, is situated within a predetermined proximity to the sensor, and a value called non-detection value, when the detectable element is situated outside the predetermined proximity to the sensor, said sensor being arranged relative to the detectable element so that, when the first connection part is situated in a position called proximity position, intermediate between the retracted position and the connection position, the sensor provides a detection signal having the detection value; and
a control unit, arranged in order to drive the actuator as a function of said detection signal, the control unit controlling a movement of the first connection part from the retracted position to the proximity position, with a force the amplitude of which is less than or equal to a maximum amplitude F₁ₘₐₓ, and controlling a movement of the first connection part from the proximity position to the connection position, with a force the amplitude of which is greater than said maximum amplitude F₁ₘₐₓ.

18. A method for electromechanical coupling of an electric vehicle with a charging station, the charging station comprising:
an electrical supply source, and
a first connection part, electrically connected to the electrical supply source and capable of having a connection position, in which it is electrically and mechanically coupled with a second connection part of the electric vehicle, a retracted position, in which it is not coupled to the second connection part, and a position called proximity position, in which it is situated in an intermediate position between the retracted position and the connection position,
the coupling method comprising: a step of moving the first connection part relative to the second connection part, with a force the amplitude of which is less than or equal to a maximum amplitude F₁ₘₐₓ, between the retracted position and the proximity position, and with a force the amplitude of which is greater than said maximum amplitude F₁ₘₐₓ between the proximity position and the connection position.

19. The coupling method according to claim 18, comprising, during the step of moving the first connection part relative to the second connection part, a monitoring step, in which it is ascertained whether the first connection part is positioned or not positioned in the intermediate position using a sensor, firmly fixed to one of the connection parts, and to a detectable element, firmly fastened to the other connection part, the detectable element capable of being detected by the sensor.
